(19) United States
(12) Patent Application Publication
(10) Pub. No.: US 2021/0404839 A1
(43) Pub. Date: Dec. 30, 2021

(54) SYSTEMS AND METHODS FOR NAVIGATIONAL MAP VERSION MANAGEMENT

(71) Applicant: TuSimple, Inc., San Diego, CA (US)

(72) Inventors: Minhao Jiang, San Diego, CA (US); Genmao Shi, San Diego, CA (US); Hsin Lu, San Diego, CA (US); Ziqi Liu, San Diego, CA (US)

(21) Appl. No.: 16/917,766

(22) Filed: Jun. 30, 2020

(51) Int. Cl. G01C 21/00; B60W 60/00

(52) U.S. Cl. CPC G01C 21/3807; B60W 60/0025; G01C 21/3885; B60W 2556/00; B60W 2552/53; B60W 2555/60; B60W 2554/4029; B60W 2552/05

(57) ABSTRACT

Systems and methods for navigational map version management are disclosed. In one aspect, a map management server includes a processor and a computer-readable memory having stored thereon a navigational map including a plurality of units, each of the units covering an area and including a plurality of objects within or adjacent to roadways within the area. The processor is configured to receive update data for the navigational map, the update data including object data to update the navigational map. The processor is also configured to create a released version of the navigational map that includes one or more updated units. The processor is further configured to provide the released version of the navigational map to an autonomous vehicle.

### BACKGROUND

### Technological Field

The described technology generally relates to systems and methods for autonomous driving, and more particularly, to navigational map version management.

### Description of the Related Technology

In autonomous driving systems, the accurate perception and prediction of the surrounding driving environment and traffic participants are crucial for making correct and safe decisions for control of the autonomous or host vehicle. The driving of an autonomous vehicle may rely on detailed maps to provide sufficiently accurate route information that can be used to select a route for navigation. As navigational maps are updated (e.g., with new information or with additional feature) version control of the various map versions can be important.

### SUMMARY OF CERTAIN INVENTIVE ASPECTS

One inventive aspect is a map management server for controlling updates to a navigational map used by an autonomous vehicle, comprising: a processor; and a computer-readable memory in communication with the processor and having stored thereon (i) a navigational map including a plurality of units, each of the units covering an area comprising a plurality of objects within or adjacent to roadways within the area and (ii) computer-executable instructions to cause the processor to: receive update data for the navigational map, the update data including object data to update the navigational map, identify one or more units of the plurality of units that are associated with the object data, compare the object data to the plurality of objects for each of the one or more units, update the one or more units based on the comparison, create a released version of the navigational map that comprises the updated one or more units, and provide the released version of the navigational map to the autonomous vehicle.

In some embodiments, the memory further has stored thereon computer-executable instructions to cause the processor to: update the version number for each of the units in the released of the navigational map.

In certain embodiments, the updating of the one or more units comprises at least of: adding a new object to the one or more units, deleting one of the objects from the one or more units, and modifying one of the objects from the one or more units.

In further embodiments, the memory further has stored thereon computer-executable instructions to cause the processor to: create released versions of the navigational map within a single chain of released versions.

In yet further embodiments, the chain of released versions is in strict chronological order.

In some embodiments, the memory further has stored thereon computer-executable instructions to cause the processor to: create a test version of the navigational map derived from the released version of the navigational map.

In certain embodiments, the test version of the navigational map comprises one or more tentative features to be tested before being included in the released version of the navigational map.

In further embodiments, the memory further has stored thereon computer-executable instructions to cause the processor to: refrain from deriving the test version of the navigational map from another test version of the navigational map.

In yet further embodiments, the memory further has stored thereon computer-executable instructions to cause the processor to: ensure that modified objects in the released version of the navigational map match previously existing objects from a previous released version of the navigational map.

In some embodiments, the memory further has stored thereon computer-executable instructions to cause the processor to: only update units in the released navigational map when the object data does not match the objects in the units.

Another aspect is a non-transitory computer readable storage medium having stored thereon instructions that, when executed, cause at least one computing device to: receive update data for a navigational map, the navigational map including a plurality of units, each of the units covering an area and comprising a plurality of objects within or adjacent to roadways within the area, the update data including object data to update the navigational map; identify one or more units of the plurality of units that are associated with the object data, compare the object data to the plurality of objects for each of the one or more units, update the one or more units based on the comparison, create a released version of the navigational map that comprises the updated one or more units; and provide the released version of the navigational map to the autonomous vehicle.

In some embodiments, the non-transitory computer readable storage medium further has stored thereon instructions that, when executed, cause at least one computing device to: update the version number for each of the units comprising at least one object corresponding to the object data.

In certain embodiments, the plurality of objects comprise at least one of: roads, lane markers, road signs, buildings, traffic cones, other vehicles, pedestrians, and bridges.

In further embodiments, the non-transitory computer readable storage medium further has stored thereon instructions that, when executed, cause at least one computing device to: create released versions of the navigational map within a single chain of released versions, the single chain of released versions being arrange in chronological order.

In still further embodiments, the chain of released versions is disallowed from deviating from the chronological order.

In yet further embodiments, the non-transitory computer readable storage medium further has stored thereon instructions that, when executed, cause at least one computing device to: create a test version of the navigational map derived from the released version of the navigational map, the test version of the navigational map comprising one or more tentative features.

In some embodiments, the non-transitory computer readable storage medium further has stored thereon instructions that, when executed, cause at least one computing device to: prevent the at least one computing device from deriving the test version of the navigational map from another test version of the navigational map.

Still another aspect is a method for controlling updates to a navigational map used by an autonomous vehicle, comprising: receiving update data for a navigational map, the navigational map including a plurality of units, each of the units covering an area and comprising a plurality of objects within or adjacent to roadways within the area, the update data including object data to update the navigational map; identifying one or more units of the plurality of units that are associated with the object data, comparing the object data to the plurality of objects for each of the one or more units, updating the one or more units based on the comparison, creating a released version of the navigational map that comprises the updated one or more units; and providing the released version of the navigational map to the autonomous vehicle.

In some embodiments, each of the plurality of objects comprises a version number.

In certain embodiments, the method further comprises: determining which of the plurality of units includes at least one object which does not match the object data; and updating the version number for all of the plurality of objects within the units that include at least one object which does not match the object data.

### BRIEF DESCRIPTION OF THE DRAWINGS

FIG. 1 is a block diagram illustrating an example ecosystem including an in-vehicle control system and an image processing module in accordance with aspects of this disclosure.

FIG. 2 is an example embodiment of a navigational map in accordance with aspects of this disclosure.

FIG. 3 illustrates a subsystem which can be used for navigational map version management in accordance with aspects of this disclosure.

FIG. 4 illustrates an example timeline of navigational map versions generated by the map management server of FIG. 3.

### DETAILED DESCRIPTION OF CERTAIN INVENTIVE EMBODIMENTS

### Introduction to In-Vehicle Control Systems

In the following description, for purposes of explanation, numerous specific details are set forth in order to provide a thorough understanding of the various embodiments. It will be evident, however, to one of ordinary skill in the art that the various embodiments may be practiced without these specific details.

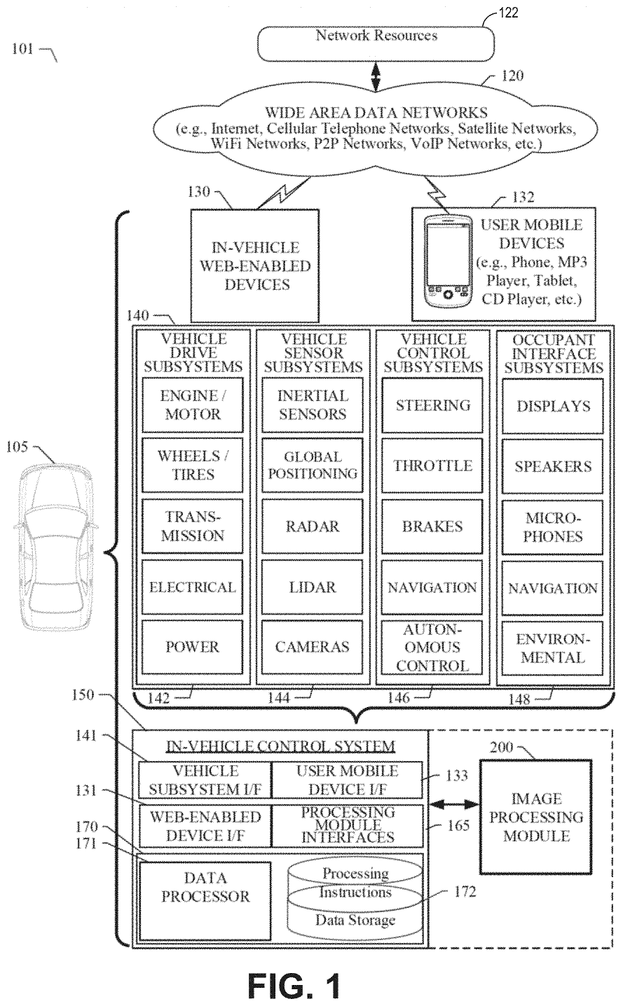

An example embodiment disclosed herein can be used in the context of an in-vehicle control system 150 in a vehicle ecosystem 101. In one example embodiment, an in-vehicle control system 150 with an image processing module 200 resident in a vehicle 105 can be configured like the architecture and ecosystem 101 illustrated in FIG. 1. However, it will be apparent to those of ordinary skill in the art that the image processing module 200 described herein can be implemented, configured, and used in a variety of other applications and systems as well.

With continuing reference to FIG. 1, a block diagram illustrates an example ecosystem 101 in which an in-vehicle control system 150 and an image processing module 200 of an example embodiment can be implemented. These components are described in more detail below. Ecosystem 101 includes a variety of systems and components that can generate and/or deliver one or more sources of information/data and related services to the in-vehicle control system 150 and the image processing module 200, which can be installed in the vehicle 105. For example, a camera installed in the vehicle 105, as one of the devices of vehicle subsystems 140, can generate image and timing data that can be received by the in-vehicle control system 150. The in-vehicle control system 150 and the image processing module 200 executing therein can receive this image and timing data input. As described in more detail below, the image processing module 200 can process the image input and extract object features (also simply referred to as “objects”), which can be used by an autonomous vehicle control subsystem, as another one of the subsystems of vehicle subsystems 140. The autonomous vehicle control subsystem, for example, can use the real-time extracted object features to safely and efficiently navigate and control the vehicle 105 through a real world driving environment while avoiding obstacles and safely controlling the vehicle. As used herein, an object may refer to any physical body that can be sensed by the vehicle sensors including, for example, roads, lane markers (e.g., a solid line, dashed line, or other markers on the road), road signs, buildings, traffic cones, other vehicles, pedestrians, bridges, etc.

In an example embodiment as described herein, the in-vehicle control system 150 can be in data communication with a plurality of vehicle subsystems 140, all of which can reside in a user's vehicle 105. A vehicle subsystem interface 141 is provided to facilitate data communication between the in-vehicle control system 150 and the plurality of vehicle subsystems 140. The in-vehicle control system 150 can include a data processor 171 configured to execute the image processing module 200 for processing image data received from one or more of the vehicle subsystems 140. The data processor 171 can be combined with a data storage device 172 as part of a computing system 170 in the in-vehicle control system 150. The data storage device 172 can be used to store data, processing parameters, and data processing instructions. A processing module interface 165 can be provided to facilitate data communications between the data processor 171 and the image processing module 200. In various example embodiments, a plurality of processing modules, configured similarly to image processing module 200, can be provided for execution by data processor 171. As shown by the dashed lines in FIG. 1, the image processing module 200 can be integrated into the in-vehicle control system 150, optionally downloaded to the in-vehicle control system 150, or deployed separately from the in-vehicle control system 150.

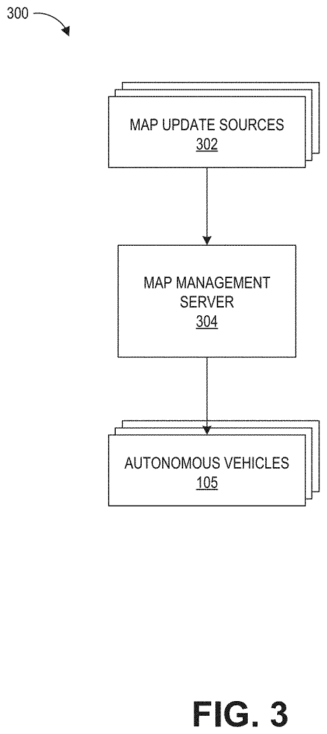

Although not illustrated in FIG. 1, the network resources 122 may include a map management subsystem 300 (e.g., as shown in FIG. 3). In certain embodiments, the map management subsystem 300 is configured to control updates to the navigational map used by the autonomous vehicle 105. Further details regarding the subsystem 300 are provided below.

The in-vehicle control system 150 can be configured to receive or transmit data to/from a wide-area network 120 and network resources 122 connected thereto. An in-vehicle web-enabled device 130 and/or a user mobile device 132 can be used to communicate via network 120. A web-enabled device interface 131 can be used by the in-vehicle control system 150 to facilitate data communication between the in-vehicle control system 150 and the network 120 via the in-vehicle web-enabled device 130. Similarly, a user mobile device interface 133 can be used by the in-vehicle control system 150 to facilitate data communication between the in-vehicle control system 150 and the network 120 via the user mobile device 132. In this manner, the in-vehicle control system 150 can obtain real-time access to network resources 122 via network 120. The network resources 122 can be used to obtain processing modules for execution by data processor 171, data content to train internal neural networks, system parameters, or other data.

The ecosystem 101 can include a wide area data network 120. The network 120 represents one or more conventional wide area data networks, such as the Internet, a cellular telephone network, satellite network, pager network, a wireless broadcast network, gaming network, WiFi network, peer-to-peer network, Voice over IP (VoIP) network, etc. One or more of these networks 120 can be used to connect a user or client system with network resources 122, such as websites, servers, central control sites, or the like. The network resources 122 can generate and/or distribute data, which can be received in vehicle 105 via in-vehicle web-enabled devices 130 or user mobile devices 132. The network resources 122 can also host network cloud services, which can support the functionality used to compute or assist in processing image input or image input analysis. Antennas can serve to connect the in-vehicle control system 150 and the image processing module 200 with the data network 120 via cellular, satellite, radio, or other conventional signal reception mechanisms. Such cellular data networks are currently available (e.g., Verizon™, AT&T™, T-Mobile™, etc.). Such satellite-based data or content networks are also currently available (e.g., SiriusXM™, HughesNet™, etc.). The broadcast networks, such as AM/FM radio networks, pager networks, UHF networks, gaming networks, WiFi networks, peer-to-peer networks, Voice over IP (VoIP) networks, and the like are also available. Thus, the in-vehicle control system 150 and the image processing module 200 can receive web-based data or content via an in-vehicle web-enabled device interface 131, which can be used to connect with the in-vehicle web-enabled device receiver 130 and network 120. In this manner, the in-vehicle control system 150 and the image processing module 200 can support a variety of network-connectable in-vehicle devices and systems from within a vehicle 105.

As shown in FIG. 1, the in-vehicle control system 150 and the image processing module 200 can also receive data, image processing control parameters, and training content from user mobile devices 132, which can be located inside or proximately to the vehicle 105. The user mobile devices 132 can represent standard mobile devices, such as cellular phones, smartphones, personal digital assistants (PDA's), MP3 players, tablet computing devices (e.g., iPad™), laptop computers, CD players, and other mobile devices, which can produce, receive, and/or deliver data, image processing control parameters, and content for the in-vehicle control system 150 and the image processing module 200. As shown in FIG. 1, the mobile devices 132 can also be in data communication with the network cloud 120. The mobile devices 132 can source data and content from internal memory components of the mobile devices 132 themselves or from network resources 122 via network 120. Additionally, mobile devices 132 can themselves include a GPS data receiver, accelerometers, WiFi triangulation, or other geo-location sensors or components in the mobile device, which can be used to determine the real-time geo-location of the user (via the mobile device) at any moment in time. In any case, the in-vehicle control system 150 and the image processing module 200 can receive data from the mobile devices 132 as shown in FIG. 1.

Referring still to FIG. 1, the example embodiment of ecosystem 101 can include vehicle operational subsystems 140. For embodiments that are implemented in a vehicle 105, many standard vehicles include operational subsystems, such as electronic control units (ECUs), supporting monitoring/control subsystems for the engine, brakes, transmission, electrical system, emissions system, interior environment, and the like. For example, data signals communicated from the vehicle operational subsystems 140 (e.g., ECUs of the vehicle 105) to the in-vehicle control system 150 via vehicle subsystem interface 141 may include information about the state of one or more of the components or subsystems of the vehicle 105. In particular, the data signals, which can be communicated from the vehicle operational subsystems 140 to a Controller Area Network (CAN) bus of the vehicle 105, can be received and processed by the in-vehicle control system 150 via vehicle subsystem interface 141. Embodiments of the systems and methods described herein can be used with substantially any mechanized system that uses a CAN bus or similar data communications bus as defined herein, including, but not limited to, industrial equipment, boats, trucks, machinery, or automobiles; thus, the term “vehicle” as used herein can include any such mechanized systems. Embodiments of the systems and methods described herein can also be used with any systems employing some form of network data communications; however, such network communications are not required.

Referring still to FIG. 1, the example embodiment of ecosystem 101, and the vehicle operational subsystems 140 therein, can include a variety of vehicle subsystems in support of the operation of vehicle 105. In general, the vehicle 105 may take the form of a car, truck, motorcycle, bus, boat, airplane, helicopter, lawn mower, earth mover, snowmobile, aircraft, recreational vehicle, amusement park vehicle, farm equipment, construction equipment, tram, golf cart, train, and trolley, for example. Other vehicles are possible as well. The vehicle 105 may be configured to operate fully or partially in an autonomous mode. For example, the vehicle 105 may control itself while in the autonomous mode, and may be operable to determine a current state of the vehicle and its environment, determine a predicted behavior of at least one other vehicle in the environment, determine a confidence level that may correspond to a likelihood of the at least one other vehicle to perform the predicted behavior, and control the vehicle 105 based on the determined information. While in autonomous mode, the vehicle 105 may be configured to operate without human interaction.

The vehicle 105 may include various vehicle subsystems such as a vehicle drive subsystem 142, vehicle sensor subsystem 144, vehicle control subsystem 146, and occupant interface subsystem 148. As described above, the vehicle 105 may also include the in-vehicle control system 150, the computing system 170, and the image processing module 200. The vehicle 105 may include more or fewer subsystems and each subsystem could include multiple elements. Further, each of the subsystems and elements of vehicle 105 could be interconnected. Thus, one or more of the described functions of the vehicle 105 may be divided up into additional functional or physical components or combined into fewer functional or physical components. In some further examples, additional functional and physical components may be added to the examples illustrated by FIG. 1.

The vehicle drive subsystem 142 may include components operable to provide powered motion for the vehicle 105. In an example embodiment, the vehicle drive subsystem 142 may include an engine or motor, wheels/tires, a transmission, an electrical subsystem, and a power source. The engine or motor may be any combination of an internal combustion engine, an electric motor, steam engine, fuel cell engine, propane engine, or other types of engines or motors. In some example embodiments, the engine may be configured to convert a power source into mechanical energy. In some example embodiments, the vehicle drive subsystem 142 may include multiple types of engines or motors. For instance, a gas-electric hybrid car could include a gasoline engine and an electric motor. Other examples are possible.

The wheels of the vehicle 105 may be standard tires. The wheels of the vehicle 105 may be configured in various formats, including a unicycle, bicycle, tricycle, or a four-wheel format, such as on a car or a truck, for example. Other wheel geometries are possible, such as those including six or more wheels. Any combination of the wheels of vehicle 105 may be operable to rotate differentially with respect to other wheels. The term wheel may generally refer to a structure comprising a rim configured to be fixedly attached to a tire, which is typically formed of rubber. Optionally, a wheel may include a hubcap attached to an outer surface of the rim or the tire may be exposed to the environment without the inclusion of a hubcap.

The wheels of a given vehicle may represent at least one wheel that is fixedly coupled to the transmission and at least one tire coupled to a rim of the wheel that could make contact with the driving surface. The wheels may include a combination of metal and rubber, or another combination of materials. The transmission may include elements that are operable to transmit mechanical power from the engine to the wheels. For this purpose, the transmission could include a gearbox, a clutch, a differential, and drive shafts. The transmission may include other elements as well. The drive shafts may include one or more axles that could be coupled to one or more wheels. The electrical system may include elements that are operable to transfer and control electrical signals in the vehicle 105. These electrical signals can be used to activate lights, servos, electrical motors, and other electrically driven or controlled devices of the vehicle 105. The power source may represent a source of energy that may, in full or in part, power the engine or motor. That is, the engine or motor could be configured to convert the power source into mechanical energy. Examples of power sources include gasoline, diesel, other petroleum-based fuels, propane, other compressed gas-based fuels, ethanol, fuel cell, solar panels, batteries, and other sources of electrical power. The power source could additionally or alternatively include any combination of fuel tanks, batteries, capacitors, or flywheels. The power source may also provide energy for other subsystems of the vehicle 105.

The vehicle sensor subsystem 144 may include a number of sensors configured to sense information about an environment or condition of the vehicle 105. For example, the vehicle sensor subsystem 144 may include an inertial measurement unit (IMU), a Global Positioning System (GPS) transceiver, a RADAR unit, a laser range finder/LIDAR unit, and one or more cameras or image capture devices. The optical sensor may be embodied as a LiDAR detector or a camera (e.g., a conventional visible wavelength camera). The vehicle sensor subsystem 144 may also include sensors configured to monitor internal systems of the vehicle 105 (e.g., an 02 monitor, a fuel gauge, an engine oil temperature). Other sensors are possible as well. One or more of the sensors included in the vehicle sensor subsystem 144 may be configured to be actuated separately or collectively in order to modify a position, an orientation, or both, of the one or more sensors.

The IMU may include any combination of sensors (e.g., accelerometers and gyroscopes) configured to sense position and orientation changes of the vehicle 105 based on inertial acceleration. The GPS transceiver may be any sensor configured to estimate a geographic location of the vehicle 105. For this purpose, the GPS transceiver may include a receiver/transmitter operable to provide information regarding the position of the vehicle 105 with respect to the Earth. The RADAR unit may represent a system that utilizes radio signals to sense objects within the local environment of the vehicle 105. In some embodiments, in addition to sensing the objects, the RADAR unit may additionally be configured to sense the speed and the heading of the objects proximate to the vehicle 105. The laser range finder or LIDAR unit may be any sensor configured to sense objects in the environment in which the vehicle 105 is located using lasers. In an example embodiment, the laser range finder/LIDAR unit may include one or more laser sources, a laser scanner, and one or more detectors, among other system components. The laser range finder/LIDAR unit can be configured to operate in a coherent (e.g., using heterodyne detection) or an incoherent detection mode. The cameras may include one or more devices configured to capture a plurality of images of the environment of the vehicle 105. The cameras may be still image cameras or motion video cameras.

The vehicle control system 146 may be configured to control operation of the vehicle 105 and its components. Accordingly, the vehicle control system 146 may include various elements such as a steering unit, a throttle, a brake unit, a navigation unit, and an autonomous control unit.

The steering unit may represent any combination of mechanisms that may be operable to adjust the heading of vehicle 105. The throttle may be configured to control, for instance, the operating speed of the engine and, in turn, control the speed of the vehicle 105. The brake unit can include any combination of mechanisms configured to decelerate the vehicle 105. The brake unit can use friction to slow the wheels in a standard manner. In other embodiments, the brake unit may convert the kinetic energy of the wheels to electric current. The brake unit may take other forms as well. The navigation unit may be any system configured to determine a driving path or route for the vehicle 105. The navigation unit may additionally be configured to update the driving path dynamically while the vehicle 105 is in operation. In some embodiments, the navigation unit may be configured to incorporate data from the image processing module 200, the GPS transceiver, and one or more predetermined maps so as to determine the driving path for the vehicle 105. The autonomous control unit may represent a control system configured to identify, evaluate, and avoid or otherwise negotiate potential obstacles in the environment of the vehicle 105. In general, the autonomous control unit may be configured to control the vehicle 105 for operation without a driver or to provide driver assistance in controlling the vehicle 105. In some embodiments, the autonomous control unit may be configured to incorporate data from the image processing module 200, the GPS transceiver, the RADAR, the LIDAR, the cameras, and other vehicle subsystems to determine the driving path or trajectory for the vehicle 105. The vehicle control system 146 may additionally or alternatively include components other than those shown and described.

Occupant interface subsystems 148 may be configured to allow interaction between the vehicle 105 and external sensors, other vehicles, other computer systems, and/or an occupant or user of vehicle 105. For example, the occupant interface subsystems 148 may include standard visual display devices (e.g., plasma displays, liquid crystal displays (LCDs), touchscreen displays, heads-up displays, or the like), speakers or other audio output devices, microphones or other audio input devices, navigation interfaces, and interfaces for controlling the internal environment (e.g., temperature, fan, etc.) of the vehicle 105.

In an example embodiment, the occupant interface subsystems 148 may provide, for instance, capabilities for a user/occupant of the vehicle 105 to interact with the other vehicle subsystems. The visual display devices may provide information to a user of the vehicle 105. The user interface devices can also be operable to accept input from the user via a touchscreen. The touchscreen may be configured to sense at least one of a position and a movement of a user's finger via capacitive sensing, resistance sensing, or a surface acoustic wave process, among other possibilities. The touchscreen may be capable of sensing finger movement in a direction parallel or planar to the touchscreen surface, in a direction normal to the touchscreen surface, or both, and may also be capable of sensing a level of pressure applied to the touchscreen surface. The touchscreen may be formed of one or more translucent or transparent insulating layers and one or more translucent or transparent conducting layers. The touchscreen may take other forms as well.

In other instances, the occupant interface subsystems 148 may provide capabilities for the vehicle 105 to communicate with devices within its environment. The microphone may be configured to receive audio (e.g., a voice command or other audio input) from a user of the vehicle 105. Similarly, the speakers may be configured to output audio to a user of the vehicle 105. In one example embodiment, the occupant interface subsystems 148 may be configured to wirelessly communicate with one or more devices directly or via a communication network. For example, a wireless communication system could use 3G cellular communication, such as CDMA, EVDO, GSM/GPRS, 4G cellular communication, such as WiMAX or LTE, or 5G cellular communication. Alternatively, the wireless communication system may communicate with a wireless local area network (WLAN), for example, using WIFI®. In some embodiments, the wireless communication system 146 may communicate directly with a device, for example, using an infrared link, BLUETOOTH®, or ZIGBEE®. Other wireless protocols, such as various vehicular communication systems, are possible within the context of the disclosure. For example, the wireless communication system may include one or more dedicated short range communications (DSRC) devices that may include public or private data communications between vehicles and/or roadside stations.

Many or all of the functions of the vehicle 105 can be controlled by the computing system 170. The computing system 170 may include at least one data processor 171 (which can include at least one microprocessor) that executes processing instructions stored in a non-transitory computer readable medium, such as the data storage device 172. The computing system 170 may also represent a plurality of computing devices that may serve to control individual components or subsystems of the vehicle 105 in a distributed fashion. In some embodiments, the data storage device 172 may contain processing instructions (e.g., program logic) executable by the data processor 171 to perform various functions of the vehicle 105, including those described herein in connection with the drawings. The data storage device 172 may contain additional instructions as well, including instructions to transmit data to, receive data from, interact with, or control one or more of the vehicle drive subsystem 142, the vehicle sensor subsystem 144, the vehicle control subsystem 146, and the occupant interface subsystems 148.

In addition to the processing instructions, the data storage device 172 may store data such as image processing parameters, training data, roadway maps, and path information, among other information. Such information may be used by the vehicle 105 and the computing system 170 during the operation of the vehicle 105 in the autonomous, semi-autonomous, and/or manual modes.

The vehicle 105 may include a user interface for providing information to or receiving input from a user or occupant of the vehicle 105. The user interface may control or enable control of the content and the layout of interactive images that may be displayed on a display device. Further, the user interface may include one or more input/output devices within the set of occupant interface subsystems 148, such as the display device, the speakers, the microphones, or a wireless communication system.

The computing system 170 may control the function of the vehicle 105 based on inputs received from various vehicle subsystems (e.g., the vehicle drive subsystem 142, the vehicle sensor subsystem 144, and the vehicle control subsystem 146), as well as from the occupant interface subsystem 148. For example, the computing system 170 may use input from the vehicle control system 146 in order to control the steering unit to avoid an obstacle detected by the vehicle sensor subsystem 144 and the image processing module 200, move in a controlled manner, or follow a path or trajectory based on output generated by the image processing module 200. In an example embodiment, the computing system 170 can be operable to provide control over many aspects of the vehicle 105 and its subsystems.

Although FIG. 1 shows various components of vehicle 105, e.g., vehicle subsystems 140, computing system 170, data storage device 172, and image processing module 200, as being integrated into the vehicle 105, one or more of these components could be mounted or associated separately from the vehicle 105. For example, data storage device 172 could, in part or in full, exist separate from the vehicle 105. Thus, the vehicle 105 could be provided in the form of device elements that may be located separately or together. The device elements that make up vehicle 105 could be communicatively coupled together in a wired or wireless fashion.

Additionally, other data and/or content (denoted herein as ancillary data) can be obtained from local and/or remote sources by the in-vehicle control system 150 as described above. The ancillary data can be used to augment, modify, or train the operation of the image processing module 200 based on a variety of factors including, the context in which the user is operating the vehicle (e.g., the location of the vehicle, the specified destination, direction of travel, speed, the time of day, the status of the vehicle, etc.), and a variety of other data obtainable from the variety of sources, local and remote, as described herein.

In a particular embodiment, the in-vehicle control system 150 and the image processing module 200 can be implemented as in-vehicle components of vehicle 105. In various example embodiments, the in-vehicle control system 150 and the image processing module 200 in data communication therewith can be implemented as integrated components or as separate components. For example, the image processing module 200 can be included as a set of instructions stored in a non-transitory computer readable medium, such as the data storage device 172, for causing the data processor 171 to perform various image processing functionality. In an example embodiment, the software components of the in-vehicle control system 150 and/or the image processing module 200 can be dynamically upgraded, modified, and/or augmented by use of the data connection with the mobile devices 132 and/or the network resources 122 via network 120. The in-vehicle control system 150 can periodically query a mobile device 132 or a network resource 122 for updates or updates can be pushed to the in-vehicle control system 150.

### Systems and Methods for Navigational Map Version Management

In the various example embodiments disclosed herein, a system and method are provided for navigational map version management, which can be employed in the context of autonomous vehicles 105 in some embodiments. Embodiments of the autonomous vehicle 105 include a semi-truck having a tractor and at least one trailer, an articulated bus, a train, a passenger car, etc.

Autonomous vehicles 105 can use detailed navigational maps in selecting a route between a current location and a destination for navigation. In order to ensure that the autonomous vehicle 105 has sufficient data to navigate through complex road systems, the navigational maps 210 used have a high level of detail including lane level information, speed limit data, static objects on or adjacent to the roadways, etc. High-definition (HD) maps generally refer to a category of navigational maps 210 having sufficient precision for navigation of autonomous vehicles 105. For example, HD maps can define properties of the lanes for all routes in the mapped area with high enough accuracy to be used for lane level navigation.

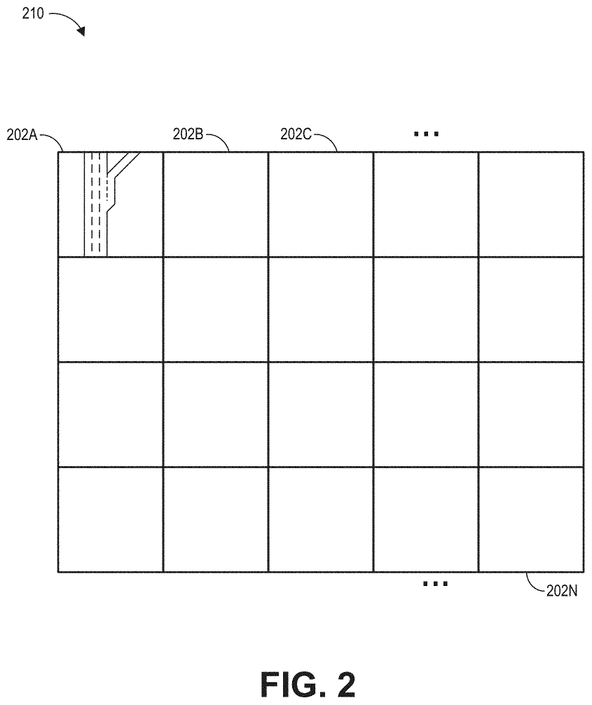

FIG. 2 is an example embodiment of a navigational map 210 in accordance with aspects of this disclosure. Navigational maps 210 used for autonomous driving can be continuously updated to incorporate any changes in the mapped environment which could potentially affect navigation of the autonomous vehicle 105. For example, newly built roadways, construction, closures, changes to natural objects near the roadway, etc. can all affect the selection of a route for navigation. As such, navigational maps 210 are regularly updated in order to maintain accurate route information for navigation of an autonomous vehicle 105. Since the navigational map 210 may include the entire “universe” of roadways (e.g., the map may include all roadways worldwide, all roadways within a certain continent, etc.) it may be impractical to update the entirety of the navigational map 210 at once. Thus, certain systems may divide the map into units 202A, 202B, 202C, . . . , 202N, where different entities are responsible for updating the roadways within each separate unit 202A-202N. In certain embodiments, a unit 202A-202N may be a region of the navigational map 210 having about 10 km² area, however, the size of the units 202A-202N can vary and may be smaller or larger in different implementations. The size of each unit 202A-202N can also vary. In FIG. 2, an example roadway (not to scale) is illustrated in the first unit 202A for illustration purposes only. In one example, the navigational map 210 can be update based on a report from an autonomous vehicle 105 that the current version of the navigational map 210 is inaccurate. For example, an autonomous vehicle 105 may report navigation inefficiencies or errors, which can be tracked at a later time to determine whether the navigational map 210 should be updated.

In addition to map updates which reflect corresponding changes to the real-world, navigational maps 210 can also be updated to include new features which were unavailable in previous versions of the navigational map 210. It can be important to test new map features prior to releasing the new features to all autonomous vehicles 105 to ensure that the new features function as intended without introducing unintended functionality or breaking functionality associated with legacy navigational map 210 features. As navigational maps 210 are updated (e.g., with new information and/or with additional feature(s)) control of the navigational map 210 versions can be important.

Traditional map management systems include software systems designed to efficiently store and query spatial information. The spatial information stored within a map management system describes road network(s) by the location and properties of each portion of the road network. These details can be important to achieving Society of Automotive Engineers (SAE) Level 4 autonomous driving systems.

In order to efficiently query objects from a navigational map 210, certain Geo-Hash algorithms have been applied in traditional autonomous driving systems. Geo-Hash algorithms can be used to transform navigational map 210 objects into a unique string based on the coordinates of the object and describe the shape and location of the object to make comparisons between different navigational map 210 versions easier. Traditional map management systems can also provide support for navigational map 210 object updates, which can involve the insertion, deletion, and/or modification of object entries into the navigational map 210 database.

Even when the navigation map 210 is still under development, traditional map management systems may have only one version of the navigational map 210 at any specific time. In other words, traditional map management systems may only use a single branch of navigation map 210, which may not be compatible with other algorithm modules which rely on the navigational map 210, such as the autonomous vehicle's 105 navigation subsystem and/or motion planning subsystem. One advantage to allowing for branching of the navigational map 210 update versions is that different tentative features may be added to the navigational maps 210 for testing, which can be accomplished by having more than one branch of test-only navigational maps 210 at the same time, where each test navigational map 210 can implement a different set of tentative features. As used herein, tentative features may refer to any functionality that may be developed in the future to be added to the navigational map 210. In addition, it can be important for a testing system (e.g., an autonomous vehicle 105 testing a set of tentative features) to require a specific version of the navigational map 210 rather than the latest navigational map 210 version in order to control variables during a unit 202A-202N test (e.g., testing one or more specific units 202A-202N of the navigation map 210) or an integration test (e.g., testing whether the integration or inclusion of a set of tentative features into the navigational map 210 provides the desired functionality or results in any errors in the navigational map 210).

Another disadvantage for traditional map management systems is that consistency is not strictly guaranteed in traditional map management systems. For example, when querying objects within the navigational map 210, traditional map management systems tend to return the latest version of map objects irrespective of whether the returned objects will connect with objects in previous versions of the navigational map 210. However, it can be important for the navigational system of an autonomous vehicle 105 to maintain the integrity of the navigational map 210 by ensuring that objects in each version of the navigational map 210 are connected to previous versions of the same objects in the previous versions of the navigational map 210.

FIG. 3 illustrates a subsystem 300 which can be used for navigational map version management in accordance with aspects of this disclosure. The subsystem 300 includes a plurality of map update sources 302, a map management server 304, and a plurality of autonomous vehicles 105. In some embodiments, each of the map update source(s) 302 may correspond to a different entity responsible for updating the roadways within a single unit 202A-202N of the map. However, in other embodiments, one map update source 302 may be used to update a plurality of units 202A-202N.

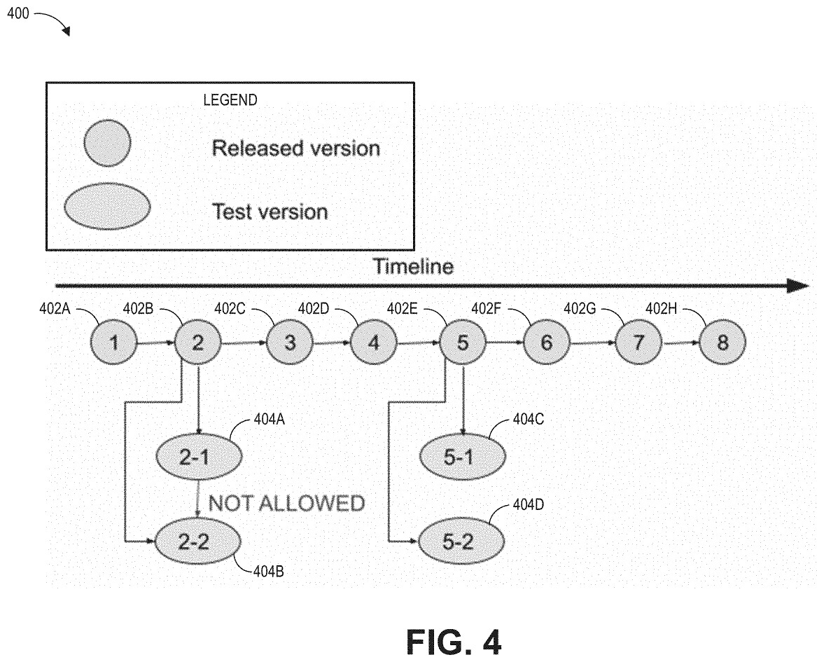

The map management server 304 is configured to update the navigational map 210 based on the data received from the map update sources 302 and provide the updated navigational map 210 to the autonomous vehicles 105 for navigation. The map management server 304 can include a processor and a computer-readable memory in communication with the processor storing computer-executable instructions to cause the processor to perform certain functions associated with updating the navigational map 210. For example, the map management server 304 can be configured to perform any one or more of the navigational map 210 update procedures discussed below in connection with FIG. 4.

FIG. 4 illustrates an example timeline 400 of navigational map versions generated by the map management server 304 of FIG. 3. As indicated by the legend, the map management server 304 can generate released versions 402A-402H as well as test versions 404A-404D of the navigational map 210.

In certain embodiments, the subsystem 300 can update the navigational map 210 using procedures defining certain unit-based editing of the navigational map 210. In order to perform unit-based editing, the subsystem 300 can, for each time in which any object(s) are added, deleted, and/or modified, update the version numbers for the entire unit(s) 202A-202N in which the changed object(s) are located. For example, the subsystem 300 can update the version number of every object within a unit 202A-202N in which there is an update to at least one object in the unit 202A-202N (e.g., at least one object is added, deleted, and/or modified). By updating the version number of the objects within the units 202A-202N having at least one updated object, the subsystem 300 can significantly reduce the number of entities which need to be managed. For example, the number of units 202A-202N being updated will typically be less than the total number of objects being updated. In addition, updating the navigational map 210 in this way can also reduce and/or minimize the variance between versions of the updated navigational map 210.

As described above, in certain embodiments, the subsystem 300 may only update units 202A-202N having a least one updated object (e.g., at least one object is added, deleted, and/or modified), for each new version of the navigational map 210. Thus, each of the units 202A-202N where no objects are updated can remain the same as in the previous navigational map 210 version. However, the subsystem 300 can update the version number of all units for each new version of the navigational map 210, even when there are no updates to the objects within certain units. In other words, even when there are not additions, deletions, or modifications to the objects within a given unit, the version number for the given unit can still be updated for the new version of the navigational map 210.

In certain embodiments, the subsystem 300 can update the navigational map 210 using procedures defining certain chain-shape editing of the navigational map 210. As used herein, chain-shape editing generally refers to maintaining a single chain of officially released versions 402A-402H of the navigational map 210, such that each officially released version 402A-402H has a single parent and at most a single child within the chain. Thus, the subsystem 300 can ensure that there is only a single current officially released version 402A-402H of the navigational map 210. For example, the subsystem 300 can maintain a single chain of released versions 402A-402H of the navigational map 210, such that the latest released version 402A-402H is the current officially released version 402A-402H. The subsystem 300 is further configured to maintain the released version 402A-402H chain in strictly chronological order, that is, the released version 402A-402H chain may not deviate from chronological order. By maintaining the released version 402A-402H chain in this manner, the subsystem 300 can cause the iteration of navigational map 210 versions to form a consecutive single chain of released versions 402A-402H from a user's perspective. However, the subsystem 300 also allows the release of test versions 404A-404D which can be used by developers such that test versions 404A-404D can be derived from each released version 402A-402H of the chain. In certain embodiments, a test version 404A-404D may be substantially the same as the released version 402A-402H from which it is derived with the inclusion of one or more tentative features.

In some embodiments, the subsystem 300 can prevent the creating of “secondary derivative” test versions 404A-404D. That is, the subsystem 300 may allow test versions 404A-404D to fork from a released version 402A-402H of the navigational map 210, but may disallow test versions 404A-404D to fork from another test version (e.g., as illustrated in the “NOT ALLOWED” derivative of test version 404B from 404A as shown in FIG. 4). In other words, the subsystem's 300 version control may ensure that all test versions 404A-404D must derive directly from a released version 402A-402H rather than other test versions 404A-404D, such that a test version 404A-404D cannot derive another test version 404A-404D.

In certain embodiments, the subsystem 300 can update the navigational map 210 using procedures defining certain strict consistency version control of the navigational map 210. The subsystem 300 can, given the navigational map 210 version running in an autonomous vehicle 105, ensure that all of the objects returned from subsystem 300 match existing objects within the navigational map 210 of the autonomous vehicle 105 seamlessly. As used herein, a navigational map 210 that has seamless object matching may refer to a navigation map 210 in which updates to the navigational map 210 do not break existing connections between objects. For example, objects within a first unit may have connections to objects within a neighboring unit. When updating the first unit but not the second unit in the navigational map 210, the subsystem 300 can ensure that all existing connections between objects in the first unit and objects in the second unit are not broken when updating the first unit. This provides seamless connections between the updated objects in the updated navigational map 210.

In various embodiments of this disclosure, by using the subsystem 300, the autonomous vehicles 105 can receive consistent navigational map 210 service during any driving trip, along with prompt and unambiguous navigational map 210 updates. By using a single chain of released versions 402A-402H, the subsystem 300 can ensure that there is a single current officially released version 402A-402H (e.g., it is unambiguous as to which version is the current officially released version 402A-402H). Once the contents of a navigational map 210 are updated by the map management server 304 and transmitted to an autonomous vehicle 105, the autonomous vehicle 105 can still obtain the most up-to-date navigational map 105 contents without sacrificing consistency or availability. In addition, when testing a test version 404A-404D of a navigational map 210, a test module can request a specific test version 404A-404D of the navigational map 210, which can be provided by the map management server 304. The subsystem 300 can also easily and consistently track any changes between versions 402A-402H of the navigational map 210. The navigational map 210 management techniques described herein can also allow autonomous vehicles 105 to use the navigational map 210 for navigation without the need to manually select specific map files.

While there have been shown and described and pointed out the fundamental novel features of the invention as applied to certain inventive embodiments, it will be understood that the foregoing is considered as illustrative only of the principles of the invention and not intended to be exhaustive or to limit the invention to the precise forms disclosed. Modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplate. All such modifications and variations are within the scope of the invention as determined by the appended claims when interpreted in accordance with the breadth to which they are entitled.

What is claimed is:

1. A map management server for controlling updates to a navigational map used by an autonomous vehicle, comprising:
a processor; and
a computer-readable memory in communication with the processor and having stored thereon (i) a navigational map including a plurality of units, each of the units covering an area comprising a plurality of objects within or adjacent to roadways within the area and (ii) computer-executable instructions to cause the processor to:
receive update data for the navigational map, the update data including object data to update the navigational map,
identify one or more units of the plurality of units that are associated with the object data,
compare the object data to the plurality of objects for each of the one or more units,
update the one or more units based on the comparison,
create a released version of the navigational map that comprises the updated one or more units, and
provide the released version of the navigational map to the autonomous vehicle.

2. The map management server of claim 1, wherein the memory further has stored thereon computer-executable instructions to cause the processor to:
update the version number for each of the units in the released of the navigational map.

3. The map management server of claim 1, wherein the updating of the one or more units comprises at least of: adding a new object to the one or more units, deleting one of the objects from the one or more units, and modifying one of the objects from the one or more units.

4. The map management server of claim 1, wherein the memory further has stored thereon computer-executable instructions to cause the processor to:
create released versions of the navigational map within a single chain of released versions.

5. The map management server of claim 4, wherein the chain of released versions is in strict chronological order.

6. The map management server of claim 1, wherein the memory further has stored thereon computer-executable instructions to cause the processor to:
create a test version of the navigational map derived from the released version of the navigational map.

7. The map management server of claim 6, wherein the test version of the navigational map comprises one or more tentative features to be tested before being included in the released version of the navigational map.

8. The map management server of claim 1, wherein the memory further has stored thereon computer-executable instructions to cause the processor to:
refrain from deriving the test version of the navigational map from another test version of the navigational map.

9. The map management server of claim 1, wherein the memory further has stored thereon computer-executable instructions to cause the processor to:
ensure that modified objects in the released version of the navigational map match previously existing objects from a previous released version of the navigational map.

10. The map management server of claim 1, wherein the memory further has stored thereon computer-executable instructions to cause the processor to:
only update units in the released navigational map when the object data does not match the objects in the units.

11. A non-transitory computer readable storage medium having stored thereon instructions that, when executed, cause at least one computing device to:
receive update data for a navigational map, the navigational map including a plurality of units, each of the units covering an area and comprising a plurality of objects within or adjacent to roadways within the area, the update data including object data to update the navigational map;
identify one or more units of the plurality of units that are associated with the object data,
compare the object data to the plurality of objects for each of the one or more units,
update the one or more units based on the comparison,
create a released version of the navigational map that comprises the updated one or more units; and
provide the released version of the navigational map to the autonomous vehicle.

12. The non-transitory computer readable storage medium of claim 11, further having stored thereon instructions that, when executed, cause at least one computing device to:
update the version number for each of the units comprising at least one object corresponding to the object data.

13. The non-transitory computer readable storage medium of claim 11, wherein the plurality of object comprise at least one of: roads, lane markers, road signs, buildings, traffic cones, other vehicles, pedestrians, and bridges.

14. The non-transitory computer readable storage medium of claim 11, further having stored thereon instructions that, when executed, cause at least one computing device to:
create released versions of the navigational map within a single chain of released versions, the single chain of released versions being arrange in chronological order.

15. The non-transitory computer readable storage medium of claim 14, wherein the chain of released versions is disallowed from deviating from the chronological order.

16. The non-transitory computer readable storage medium of claim 11, further having stored thereon instructions that, when executed, cause at least one computing device to:
create a test version of the navigational map derived from the released version of the navigational map, the test version of the navigational map comprising one or more tentative features.

17. The non-transitory computer readable storage medium of claim 16, further having stored thereon instructions that, when executed, cause at least one computing device to:
prevent the at least one computing device from deriving the test version of the navigational map from another test version of the navigational map.

18. A method for controlling updates to a navigational map used by an autonomous vehicle, comprising:
receiving update data for a navigational map, the navigational map including a plurality of units, each of the units covering an area and comprising a plurality of objects within or adjacent to roadways within the area, the update data including object data to update the navigational map;
identifying one or more units of the plurality of units that are associated with the object data,
comparing the object data to the plurality of objects for each of the one or more units,
updating the one or more units based on the comparison,
creating a released version of the navigational map that comprises the updated one or more units; and
providing the released version of the navigational map to the autonomous vehicle.

19. The method of claim 18, wherein each of the plurality of objects comprises a version number.

20. The method of claim 19, further comprising:
determining which of the plurality of units includes at least one object which does not match the object data; and
updating the version number for all of the plurality of objects within the units that include at least one object which does not match the object data.
